(19) United States
(12) Patent Application Publication
(10) Pub. No.: US 2013/0150073 A1
(43) Pub. Date: Jun. 13, 2013

(54) METHODS AND APPARATUS FOR UPDATING INFORMATION USED IN GENERATING A SIGNAL PREDICTION MAP

(71) Applicants: Aleksandar Jovicic, Jersey City, NJ (US); Cyril Measson, Somerville, NJ (US); Thomas J. Richardson, South Orange, NJ (US)

(72) Inventors: Aleksandar Jovicic, Jersey City, NJ (US); Cyril Measson, Somerville, NJ (US); Thomas J. Richardson, South Orange, NJ (US)

(73) Assignee: QUALCOMM Incorporated, San Diego, CA (US)

(21) Appl. No.: 13/316,865

(22) Filed: Dec. 12, 2011

(51) Int. Cl. H04W 64/00

(52) U.S. Cl. 455/456.1

(57) ABSTRACT

A set of signal prediction map generation parameters, used to generate a signal prediction map to determine mobile device location, are initially modeled as large variance random variables. A network device, e.g., a server, receives estimated positions of mobiles and corresponding signal measurements, e.g., received signal power measurements, taken at those estimated positions by the mobiles. Received signal measurement information and corresponding estimated position information from a mobile is used to update one or more of the signal prediction map generation parameter distributions. After multiple updates to a distribution of a signal prediction map generation parameter, the network node transmits a prediction parameter update signal communicating the new distribution of the signal prediction parameter to be subsequently used by the mobile devices in the system when generating a signal prediction map and estimating its position.

### FIELD

Various embodiments are directed to mobile device position determination, and more particularly, to methods and apparatus related to learning signal prediction map generation parameters.

### BACKGROUND

Positioning systems based on signal fingerprinting, e.g., RF signal matching, rely on fingerprint prediction, e.g., predicting what RF signals will be detectable at a particular location. The prediction may be represented using a map of the geographic region over which the positioning system operates. The map may contain information describing the spatial (positional) variation of the physical characteristics of the signal(s) that constitute the fingerprint, e.g., RF prediction map, or some portion thereof. In many cases the accuracy of the position estimate produced by a positioning algorithm using a fingerprint map depends upon the accuracy of the underlying fingerprinting map.

Fingerprint, e.g., RF prediction maps, may be obtained by various methods. One approach is to determine the fingerprint maps using parametric models of the propagation of the physical signal used by the positioning system. For example, in the case of RF signal based positioning, a ray-tracing algorithm may be used to compute an estimate of received signal power or signal propagation time for a given transmit location. In the indoor setting, e.g., inside a building, the propagation predicted by the ray-tracing algorithm may depend on a number of parameters, such as the RF properties of the wall/ceiling/floor materials, including reflection, refraction and diffraction effects. One benefit of using a parametric model is that the parameters, together with the building map, constitute a compact representation of the information used to estimate signal characteristics for arbitrary transmit and receive locations. If the number of potential transmit and receive locations is large, then such a model can be a more efficient means of data representation as compared to, say, directly storing the fingerprint value as a function of transmit and receive position. Efficient representation implies smaller storage requirements and/or more efficient communication of map information. Communication of map information often plays an important role in positioning systems.

One problem with the parametric model based approach to generating fingerprint maps is that the reliability of the map depends on the accuracy of the parameters used in generating the map. It can be costly and/or impractical to conduct a large scale initial RF survey at a particular site to generate an accurate set of parameters.

In view of the above discussion, it should be appreciated that there is a need for methods and apparatus which can be used in learning a set of parameters used to generate an accurate fingerprint map without requiring a complete RF survey to be conducted at the site.

### SUMMARY

Various embodiments are directed to methods and apparatus for updating signal prediction map generation parameters. In various embodiments, a set of signal prediction map generation parameters are initially modeled as random variables, where in some embodiments, the variables' variances are intentionally set larger than what would be produced by actual measurements of actual variables, e.g., parameters. For example, a wall loss parameter is intentionally initially modeled as a random variable having a variance which is much larger than the variance that would be obtained based on a set of actual wall loss measurements from a measurement survey and/or based on the known properties of the wall, e.g., the approximate thickness of the wall, the approximate expected amount of variation in wall thickness, the composition of the wall and/or the signal attenuation properties of the wall material. A network device, e.g., a server, receives estimated positions of mobiles and corresponding signal measurements, e.g., received signal power measurements, taken at those estimated positions by the mobiles. Received signal measurement information and corresponding estimated position information from a mobile is used to update one or more of the signal prediction map generation parameter distributions. In some embodiments, the determination as to which one or more signal prediction map generation parameters should be updated in response to received signal measurements of a particular mobile wireless device is based upon the estimated location of the mobile wireless device and the type of signal path or paths between the mobile wireless device and one or more anchor points. Various different types of signal paths include an unobstructed direct signal path, a direct signal path in which the signal traverses obstructions, e.g., one or more walls causing losses, and a diffraction signal path in which the signal bends around a corner.

After multiple updates to a distribution of a signal prediction map generation parameter, the network node transmits a prediction parameter update signal communicating the new distribution of the signal prediction parameter to be subsequently used by the mobile devices in the system when generating a signal prediction map and estimating its position. In various embodiments, the network node performs multiple iterations of updating distributions of prediction map generations parameters and communicating updates to mobile devices to refine the signal prediction map parameter values, e.g., resulting in a more accurate signal prediction map.

An exemplary method of operating a network device, e.g., a server node, in accordance with some embodiments, comprises: receiving a signal measurement and a position of a first mobile wireless device and updating a previous distribution of a first signal prediction map generation parameter based on the signal measurement and the position of the first mobile wireless device to generate an updated distribution of the first signal prediction map generation parameter, said first signal prediction map generation parameter being a building structure dependent parameter. The exemplary method further comprises: transmitting a prediction parameter update signal communicating the updated distribution of the first signal prediction map generation parameter to a mobile wireless device.

An exemplary network device, e.g., a server, in accordance with some embodiments, comprises: at least one processor configured to: receive a signal measurement and a position of a first mobile wireless device; update a previous distribution of a first signal prediction map generation parameter based on the signal measurement and the position of the first mobile wireless device to generate an updated distribution of the first signal prediction map generation parameter, said first signal prediction map generation parameter being a building structure dependent parameter; and transmit a prediction parameter update signal communicating the updated distribution of the first signal prediction map generation parameter to a mobile wireless device. The exemplary network device further comprises memory coupled to said at least one processor.

While various embodiments have been discussed in the summary above, it should be appreciated that not necessarily all embodiments include the same features and some of the features described above are not necessary but can be desirable in some embodiments. Numerous additional features, embodiments and benefits of various embodiments are discussed in the detailed description which follows.

### BRIEF DESCRIPTION OF THE FIGURES

FIG. 1 is a drawing of an exemplary communications system including mobile device location determination capability using generated signal prediction maps in accordance with an exemplary embodiment.

FIG. 2A is a first portion of a flowchart of an exemplary method of operating a network device in accordance with an exemplary embodiment.

FIG. 2B is a second portion of a flowchart of an exemplary method of operating a network device in accordance with an exemplary embodiment.

FIG. 3 is an exemplary network device in accordance with an exemplary embodiment.

FIG. 4A is a first portion of an exemplary assembly of modules that may be included in the network device of FIG. 3 in accordance with an exemplary embodiment.

FIG. 4B is a second portion of an exemplary assembly of modules that may be included in the network device of FIG. 3 in accordance with an exemplary embodiment.

FIG. 5 is a drawing illustrating exemplary system of FIG. 1 at a first point in time, e.g., an initialization point.

FIG. 6 is a drawing used to illustrate anchor points transmitting reference signals which are received and measured by mobile wireless devices, which perform mobile device position estimation based on the received power of the received reference signals, stored anchor point information, stored location information, and stored initial distribution densities for prediction map generation parameters.

FIG. 7 is a drawing used to illustrate mobile wireless devices communicating mobile wireless device position estimation and corresponding signal measurement information to a network node, e.g., a server which uses the communicated information to update distribution densities for prediction map generation parameters.

FIG. 8 is a drawing used to illustrate anchor points transmitting reference signals which are received and measured by mobile wireless devices, which are located at different positions with respect to FIG. 6 and which perform mobile device position estimation based on the received power of the received reference signals, stored anchor point information, stored location information, and stored initial distribution densities for prediction map generation parameters.

FIG. 9 is a drawing used to illustrate mobile wireless devices communicating mobile wireless device position estimation and corresponding signal measurement information to a network node, e.g., a server which uses the communicated information to further update distribution densities for prediction map generation parameters.

FIG. 10 illustrates the network node, e.g., a serve, communicating its current updated distribution densities for prediction map generation parameters to the mobile wireless devices in the system via broadcast signaling transmitted by the anchor points.

FIG. 11 illustrates an exemplary five parameter model for generating a signal prediction map, a map coverage area, and exemplary ray tracing between an access point serving as an anchor point and a mobile wireless device.

FIG. 12 illustrates steps included in an exemplary parameter distribution update method in accordance with some embodiments.

FIG. 13 illustrates an exemplary parameter density evolution for signal prediction map generation parameters in accordance with an exemplary embodiment.

### DETAILED DESCRIPTION

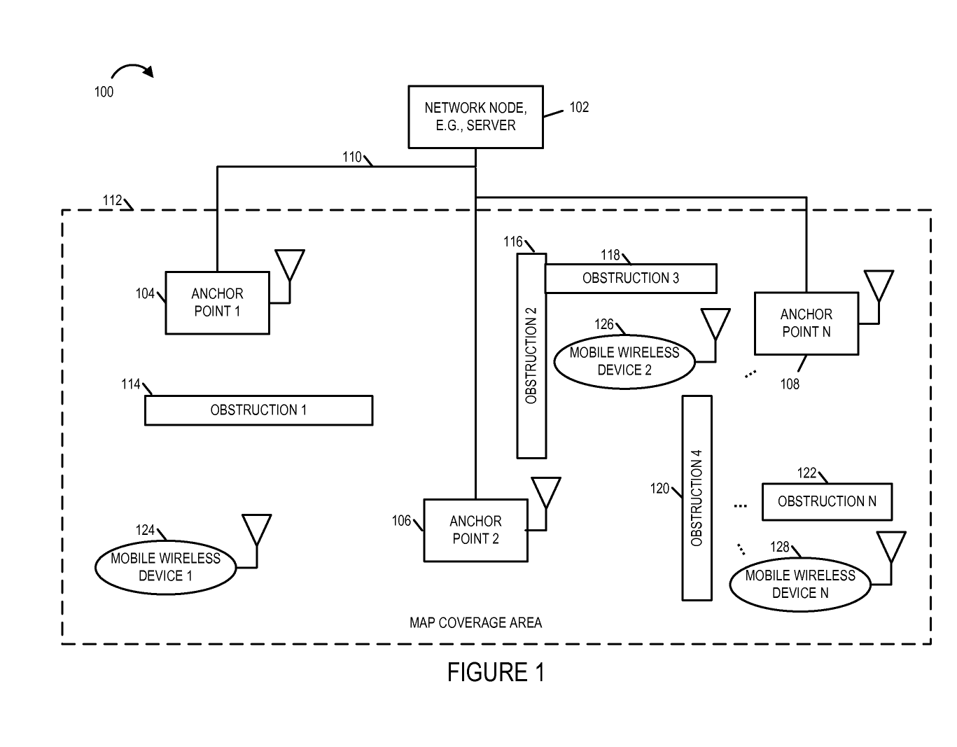

FIG. 1 is a drawing of an exemplary communications system 100 including mobile device location determination capability using generated signal prediction maps in accordance with an exemplary embodiment. Exemplary system 100 includes a network node, e.g., a server 102 coupled to a plurality of anchor points (anchor point 1 104, anchor point 2 106, . . . , anchor point N 108) via a network, e.g., a backhaul network 110. The anchor points (104, 106, . . . , 108) may be stationary or mobile devices situated at known locations within map coverage area 112. In some embodiments, some of the anchor points (104, 106, . . . , 108) are permanent anchor points at predetermined fixed locations. In some embodiments some such anchor points are base stations. In some embodiments, some of the anchor points (104, 106, . . . , 108) are temporary anchor points. In some such embodiments, some of the temporary anchor points are mobile nodes which temporarily serve as an anchor point. In some embodiments, a temporary anchor point broadcasts its location and an indication that it is currently serving as a temporary anchor point.

In addition to anchor points, system 100 includes a plurality of mobile wireless devices (mobile wireless device 1 124, mobile wireless device 2 126, . . . , mobile wireless device N 128) which may move throughout the system. Within the map coverage area 112 there are a plurality of obstructions (obstruction 1 114, obstruction 2 116, obstruction 3 118, obstruction 4 120, . . . , obstruction N 122). The map coverage area 112 is, e.g., an area within a building. The obstructions are, e.g., building walls, doors, cubicle walls, etc. The locations of the obstructions within the map coverage area 112 are known.

Anchor point nodes (104, 106, . . . , 108) transmit reference signals, e.g., at predetermined known transmission power levels, which are detected and measured by the mobile wireless devices (124, 126, . . . , 128). A mobile wireless device, e.g., mobile wireless device 1 124, includes information identifying the location of the various anchor points in map coverage area, information identifying the transmit power level of reference signals from the anchor points, information identifying the location and characteristics of various obstructions, and information corresponding to a plurality of signal prediction map generation parameters. A mobile wireless device estimates its position within the map coverage area 112 based on the received reference signals, known location of the anchor points, known location of obstructions, possible signal paths, e.g., a direct unobstructed signal path between an anchor point and the mobile device, a direct signal path between an anchor point and the mobile device in which the signal passes through one or more obstructions, a reflected signal path between an anchor point and mobile device, and a refracted signal path between the anchor point and mobile device, and the signal prediction map generation parameter information. Examples of signal prediction map generation parameters include: a wall loss parameter, a diffraction loss parameter, a direct path loss parameter, a direct path exponent parameter, a diffraction path exponent parameter, a reflection loss parameter, and a reflection loss exponent parameter. At least some of the signal prediction map generation parameters are building structure dependent parameters. There may be, and sometimes are, multiple parameters of the same type, e.g., a first wall loss parameter and a second wall loss parameter corresponding to different material walls and/or difference thickness walls. In various embodiments, the signal prediction map generation parameter information includes parameter density distribution functions corresponding to the parameters.

Mobile device position estimation information, reliability information associated with the mobile device position determination and corresponding measurement information, e.g., received power strength information, of received signals used in generating the mobile device position estimation is communicated from a mobile device, via an anchor point, to the network node 102, e.g., a server. The network node 102 collects position information, position estimate reliability information and corresponding measurement information, upon which the position determination was based, from the same mobile wireless device for multiple position determinations, e.g., at different times and/or at different locations. The network node 102 collects position information, position estimate reliability information and corresponding measurement information, upon which the position determination was based, from a plurality of mobile wireless devices in the coverage area. The network node 102 uses the collected information to update the prediction map generation parameter information. Updated position map generation parameter information is subsequently communicated, e.g., after a predetermined number of updates have been performed, from the network node 102 to the mobile wireless devices, e.g., via broadcast signaling from the anchor points.

In various embodiments, the prediction map generation parameter information includes a parameter density distribution function corresponding to each of a plurality of different parameters. In various embodiments, the initial parameter density distribution functions are not a result of measurements provided by the mobile wireless devices. In various embodiments, the initial parameter density distribution functions are intentionally more spread out, e.g., have a wider distribution, than would be expected for a parameter. Thus, in various embodiments, prediction map generation parameters are initially modeled as large random variance variables. Measurement data, position estimation data and position estimation reliability information collected from the mobile nodes is used by the network node, e.g., server 102, to update the parameter density distribution functions. The updated parameter density distribution functions are communicated to the mobile nodes. The mobile nodes use the new parameter density distribution functions in generating a new prediction map and determining mobile node location. The process is repeated and the parameter density distribution function is refined. In various embodiments, this approach of starting with unusually spread out parameter distributions functions for the map generation parameters results in a better, e.g., more accurate map than would be possible if the map generation parameters were treated as deterministic quanties.

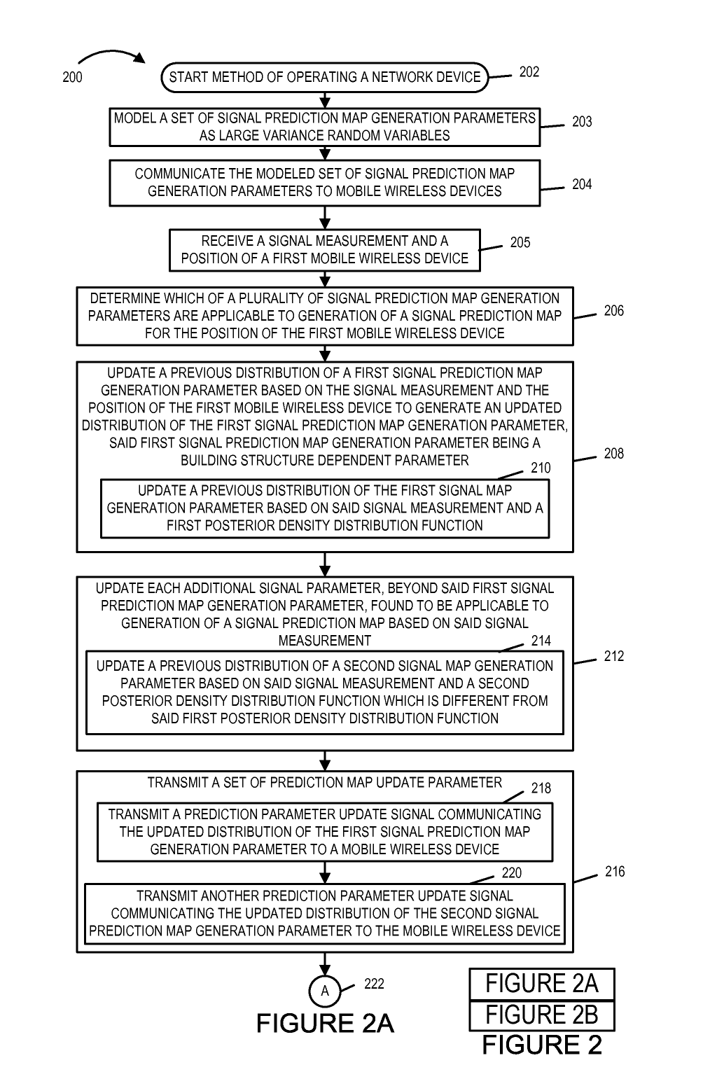

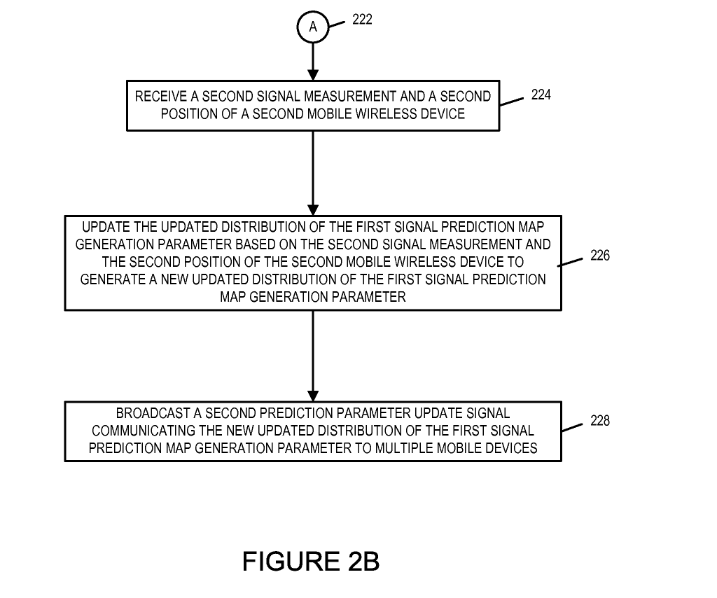

FIG. 2, comprising the combination of FIG. 2A and FIG. 2B, is a flowchart 200 of an exemplary method of operating a network device, e.g., a server, in accordance with an exemplary embodiment. The network node is, e.g., network node 102 of system 100 of FIG. 1. Operation of the exemplary method starts in step 202 where the network device is powered on and initialized. Operation proceeds from step 202 to step 203 in which the network device models a set of signal prediction map generation parameters as large variance random variables. Operation proceeds from step 203 to step 204 in which the network device communicates the modeled set of signal prediction map generation parameters from step 203 to mobile wireless devices, e.g., to be used by the mobile wireless devices to generate a signal prediction map and estimate mobile device position. In various embodiments, the communication of step 203 includes communicating quantized distributions corresponding to each of the parameters.

Operation proceeds from step 204 to step 205. In step 205, the network device receives a signal measurement and a position of a first mobile wireless device. The position in the received measurement has been determined by the first mobile wireless device based on a signal prediction map generated using the model communicated in step 204. Operation proceeds from step 205 to step 206.

In step 206 the network device determines which of a plurality of signal prediction map generation parameters are applicable to generation of a signal prediction map for the position of the first mobile wireless device. For example, consider an example, in which the set of signal prediction map generation parameters include; a wall loss parameter, a diffraction loss parameter, a direct path loss exponent parameter, and a diffraction loss exponent. In one such embodiment, a wall loss parameter is applicable if a ray from an anchor point or access point will pass through the wall to the location but not otherwise; a diffraction loss parameter is applicable if there are any corners in the path from the anchor point or access point to the location; a direct path exponent is always applicable; and a diffraction path loss exponent is applicable whenever diffraction loss is applicable. Operation proceeds from step 206 to step 208.

In step 208 the network device updates a previous distribution of a first signal prediction map generation parameter based on the signal measurement and the position of the first mobile wireless device to generate an updated distribution of the first signal prediction map generation parameter, said first signal prediction map generation parameter being a building structure dependent parameter. The previous distribution being updated is, e.g., one of the initial distributions of the model of step 203.

In some embodiments, the first signal prediction map generation parameter is one of: a wall loss parameter, a diffraction loss parameter, a direct path loss exponent parameter, a diffraction path loss exponent parameter, and a reflection loss parameter. In some embodiments, the distribution of a first signal prediction map generation parameter is an initial distribution density of said first signal prediction map generation parameter which is not based on a signal measurement provided by a mobile wireless terminal. In various embodiments, the updated distribution of the first signal prediction map generation parameter includes a plurality of quantized probability values corresponding to the first signal prediction map generation parameter.

Step 208 includes step 210 in which the network device updates a previous distribution of the first signal map generation parameter based on said signal measurement and a first posterior density distribution function. Operation proceeds from step 208 to step 212.

In step 212 the network device updates each addition signal parameter, beyond said first signal prediction map generation parameter, found to be applicable to generation of a signal prediction map based on said signal measurement. Step 212 includes step 214 in which the network device updates a previous distribution of a second signal map generation parameter based on said signal measurement and a second posterior density distribution function which is different from said first posterior density distribution function. For example, the network node uses different functions for the wall loss parameter update than for the diffraction loss parameter update. Operation proceeds from step 212 to step 216

In step 216 the network device transmits a set of prediction map update parameters. Step 216 includes step 218 and step 220. In step 218 the network device transmits a prediction parameter update signal communicating the updated distribution of the first signal prediction map generation parameter to a mobile wireless device, and in step 220 the network device transmits another prediction parameter update signal communicating the updated distribution of the second signal prediction map generation parameter to the mobile wireless device. In some embodiments, the updated distribution of the first signal prediction map generation parameter and the updated distribution of the second signal prediction map generation parameter are communicated in the same prediction parameter update signal. In some embodiments, the transmitting of the prediction parameter update signal communicating the updated distribution of the first signal prediction map generation parameter is performed after a predetermined number of updates of said distribution of the first signal prediction map generation parameter have been performed since a previous transmission of the first signal prediction map generation parameter. Operation proceeds from step 216 via connecting node A 222 to step 224.

In step 224 the network device receives a second signal measurement and a second position of a second mobile wireless device. Operation proceeds from step 224 to step 226. In step 226 the network device updates the updated distribution of the first signal prediction map generation parameter based on the second signal measurement and the second position of the second mobile wireless device to generate a new updated distribution of the first signal prediction map generation parameter. Operation proceeds from step 226 to step 228, in which the network device broadcast a second prediction parameter update signal communicating the new updated distribution of the first signal prediction map generation parameter to multiple mobile devices.

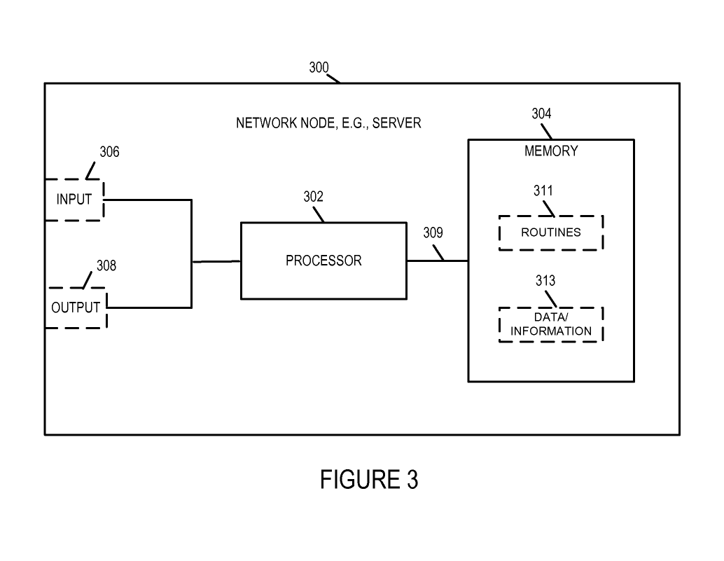

FIG. 3 is a drawing of an exemplary network device 300 in accordance with an exemplary embodiment. Exemplary network device 300 is, e.g., one of the network devices of system 100 of FIG. 1. Exemplary network device 300 may, and sometimes does, implement a method in accordance with flowchart 200 of FIG. 2.

Network device 300 includes a processor 302 and memory 304 coupled together via a bus 309 over which the various elements (302, 304) may interchange data and information. Network device 300 further includes an input module 306 and an output module 308 which may be coupled to processor 302 as shown. However, in some embodiments, the input module 306 and output module 308 are located internal to the processor 302. Input module 306 can receive input signals. Input module 306 can, and in some embodiments does, include a wireless receiver and/or a wired or optical input interface for receiving input. Output module 308 may include, and in some embodiments does include, a wireless transmitter and/or a wired or optical output interface for transmitting output. In some embodiments, memory 304 includes routines 311 and data/information 313.

In various embodiments, processor 302 is configured to: receive a signal measurement and a position of a first mobile wireless device and update a previous distribution of a first signal prediction map generation parameter based on the signal measurement and the position of the first mobile wireless device to generate an updated distribution of the first signal prediction map generation parameter, said first signal prediction map generation parameter being a building structure dependent parameter. In some such embodiments, processor 302 is further configured to transmit a prediction parameter update signal communicating the updated distribution of the first signal prediction map generation parameter to a mobile wireless device.

In some embodiments, the processor 302 is configured to transmit the prediction parameter update signal in response to a received request from a mobile wireless device. In some embodiments, processor 302 is configured to transmit the prediction parameter update signal as a broadcast signal. In some embodiments, processor 302 is configured to perform the transmitting of the prediction parameter update signal communicating the updated distribution of the first signal prediction map generation parameter after a predetermined number of updates of said distribution of the first signal prediction map generation parameter have been performed since a previous transmission of the first signal prediction map generation parameter. In some such embodiments, processor 302 is configured to perform the transmitting of the prediction parameter update signal as part of transmitting a set of prediction map update parameters

In some embodiments, the previous distribution of a first signal prediction map generation parameter is an initial distribution density of said first parameter which is not based on a signal measurement provided by a mobile wireless terminal. In various embodiments, the first signal prediction map generation parameter is one of: a wall loss parameter, diffraction loss parameter, direct path loss exponent parameter, diffraction path loss parameter and a reflection loss parameter. In some embodiments, the updated distribution includes a plurality of quantized probability values corresponding to said first parameter

In some embodiments, processor 302 is further configured to determine which of a plurality of signal prediction map generation parameters are applicable to generation of a signal prediction map for the position of the first mobile wireless device, prior to updating the first signal prediction parameter. In some such embodiments, processor 302 is further configured to: update each additional signal parameter, beyond said first signal prediction map generation parameter, found to be applicable to generation of a signal prediction map based on said signal measurement.

In some embodiments, processor 302 is configured to: update a previous distribution of the first signal map generation parameter based on said signal measurement and a first posterior density distribution function, as part of being configured to update a previous distribution of the first signal prediction map generation parameter. In some such embodiments, processor 302 is further configured to update a previous distribution of a second signal prediction map generation parameter based on said signal measurement and a second posterior density distribution function which is different from said first posterior density distribution function.

In various embodiments, processor 302 is further configured to: receive a second signal measurement and a second position of a second mobile wireless device; and update said updated distribution of the first signal prediction map generation parameter based on the second signal measurement and the second position of the second mobile wireless device to generate a new updated distribution of the first signal prediction map generation parameter. In some such embodiments, processor 302 is configured to broadcast a second prediction parameter update signal communicating the new updated distribution of the first signal prediction map generation parameter to multiple mobile devices.

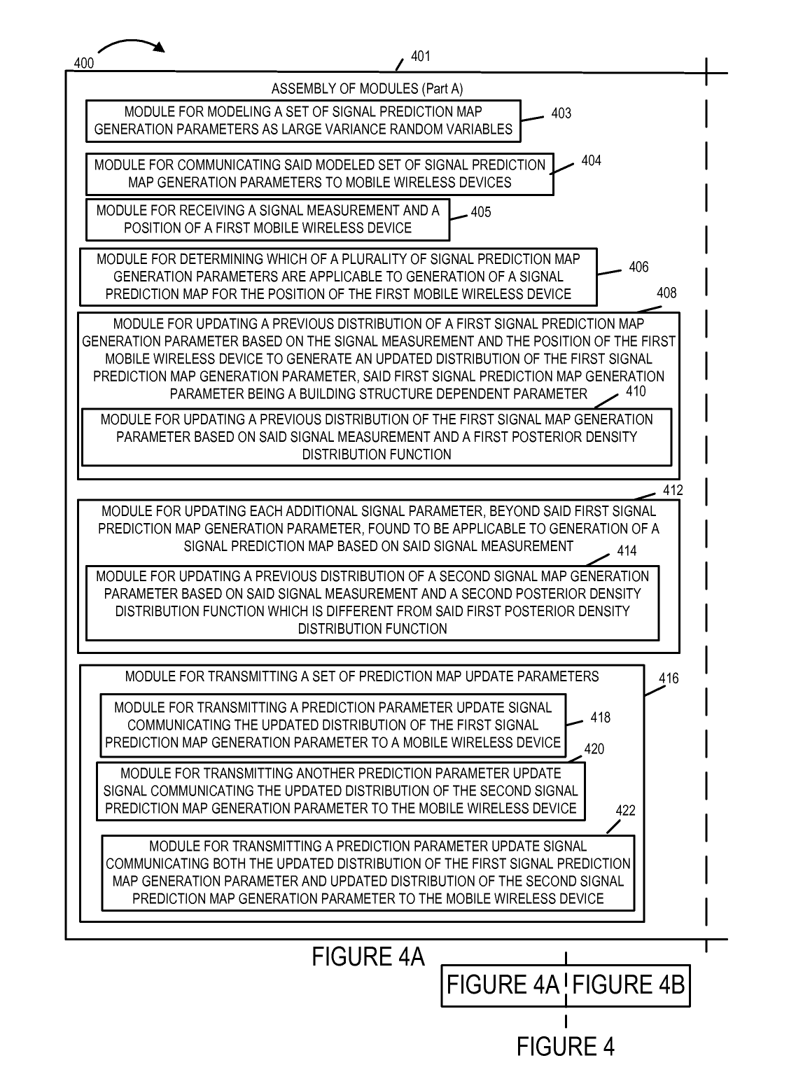

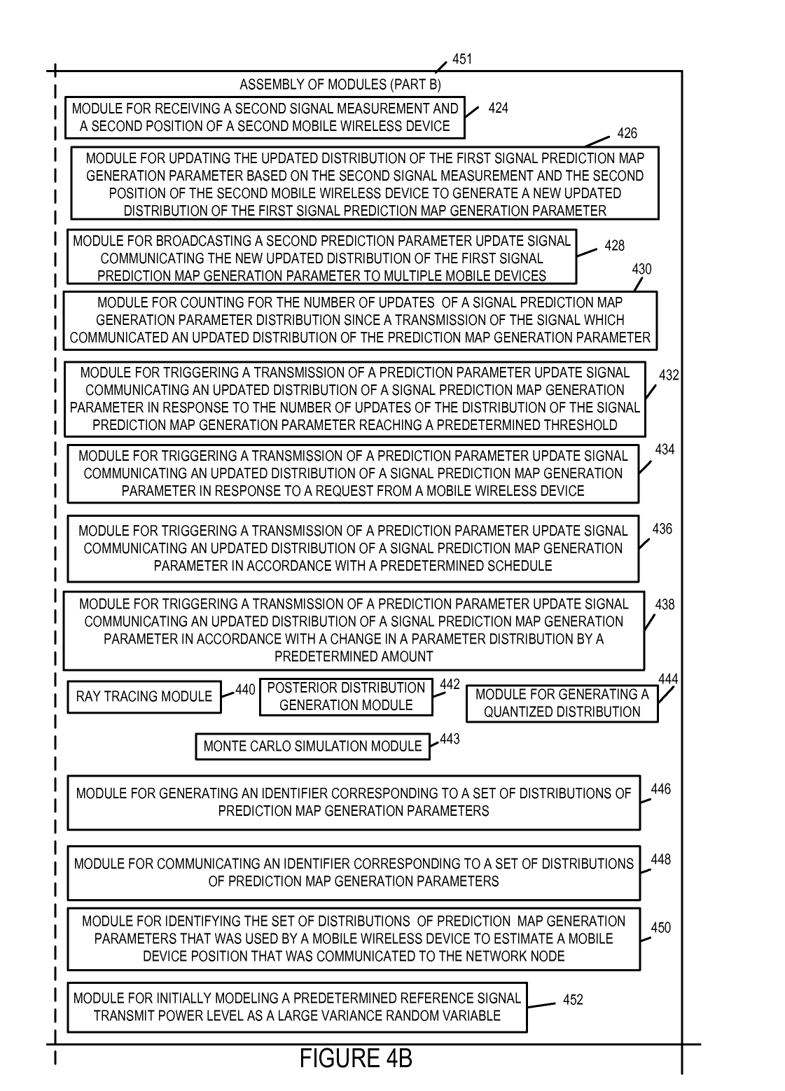

FIG. 4 is an assembly of modules 400 which can, and in some embodiments is, used in the network device 300 illustrated in FIG. 3. The modules in the assembly 400 can be implemented in hardware within the processor 302 of FIG. 3, e.g., as individual circuits. Alternatively, the modules may be implemented in software and stored in the memory 304 of network device 300 shown in FIG. 3. In some such embodiments, the assembly of modules 400 is included in routines 311 of memory 304 of device 300 of FIG. 3. While shown in the FIG. 3 embodiment as a single processor, e.g., computer, it should be appreciated that the processor 302 may be implemented as one or more processors, e.g., computers. When implemented in software the modules include code, which when executed by the processor, configure the processor, e.g., computer, 302 to implement the function corresponding to the module. In some embodiments, processor 302 is configured to implement each of the modules of the assembly of modules 400. In embodiments where the assembly of modules 400 is stored in the memory 304, the memory 304 is a computer program product comprising a computer readable medium, e.g., a non-transitory computer readable medium, comprising code, e.g., individual code for each module, for causing at least one computer, e.g., processor 302, to implement the functions to which the modules correspond.

Completely hardware based or completely software based modules may be used. However, it should be appreciated that any combination of software and hardware (e.g., circuit implemented) modules may be used to implement the functions. As should be appreciated, the modules illustrated in FIG. 4 control and/or configure the network device 300 or elements therein such as the processor 302, to perform the functions of the corresponding steps illustrated and/or described in the method of flowchart 200 of FIG. 2

Assembly of modules 400 includes the combination of Part A 401 and Part B 451. Assembly of modules 400 includes a module for modeling a set of prediction map generation parameters as large variance random variables 403, a model for communicating the modeled set of prediction map generation parameters to mobile wireless devices 404, a module for receiving a signal measurement and a position of a first mobile wireless device 405, a module for determining which of a plurality of signal prediction map generation parameters are applicable to generation of a signal prediction map for the position of the first mobile wireless device 406, a module for updating a previous distribution of a first signal prediction map generation parameter based on the signal measurement and the position of the first mobile wireless device to generate an updated distribution of the first signal prediction map generation parameter, said first signal prediction map generation parameter being a building structure dependent parameter 408, and a module for updating each additional signal parameter, beyond said first signal prediction map generation parameter, found to be applicable to generation of a signal prediction map based on said signal measurement. Module 408 includes a module for updating a previous distribution of the first signal map generation parameter based on said signal measurement and a first posterior density distribution function 410. Module 412 includes a module for updating a previous distribution of a second signal map generation parameter based on said signal measurement and a second posterior density distribution function which is different from said first posterior density distribution function 414.

Assembly of modules 400 further includes a module for transmitting a set of prediction map update parameter 416, a module for receiving a second signal measurement and a second position of a second mobile wireless device 424, a module for updating the updated distribution of the first signal prediction map generation parameter based on the second signal measurement and the second position of the second mobile wireless device to generate a new updated distribution of the first signal prediction map generation parameter 426 and a module for broadcasting a second prediction parameter update signal communicating the new updated distribution of the first signal prediction map generation parameter to multiple mobile devices 428.

Module 416 includes a module for transmitting a prediction parameter update signal communicating the updated distribution of the first signal prediction map generation parameter to a mobile wireless device 418, a module for transmitting another prediction parameter update signal communicating the updated distribution of the second signal prediction map generation parameter to a mobile wireless device 420, and a module for transmitting a prediction parameter update signal communicating both the updated distribution of the first signal prediction map generation parameter and the updated distribution of the second signal prediction map generation parameter to a mobile wireless device 421.

Assembly of modules 400 further includes a module for counting the number of updates of a signal prediction map generation parameter distribution since the last transmission of a signal which communicated an updated distribution of the prediction map generation parameter 430, a module for triggering a transmission of a prediction parameter update signal communicating an updated distribution of a signal prediction map generation parameter in response to the number of updates of the signal prediction map generation parameter reaching a predetermined threshold 432, a module for triggering a transmission of a prediction parameter update signal communicating an updated distribution of a signal prediction map generation parameter in response to a request from a mobile wireless device 434, a module for triggering a transmission of a prediction parameter update signal communicating an updated distribution of a signal prediction map generation parameter in accordance with a predetermined schedule 436, and a module for triggering a transmission of a prediction parameter update signal communicating an updated distribution of a signal prediction map generation parameter in accordance with a change in a parameter distribution by a predetermined amount 438.

Assembly of modules 428 further includes a ray tracing module 440, a posterior distribution generation module 442, a Monte Carlo simulation module 443, and a module for generating a quantized distribution 444. Ray tracing module 440 determines a path or paths between a mobile device position and an anchor point position, e.g., corresponding to mobile estimated position in the map coverage area. Ray tracing modules identifies direct unobstructed signal paths, direct signal paths including path loss through one or more obstructions, diffraction signal paths and reflected signal paths. The results of the ray tracing module 440 are used by module 406 for determining which signal prediction map generation parameters are applicable to updating. Posterior distribution generation module 442 generates posterior distribution corresponding to signal prediction map generation parameters. Monte Carlo simulation module 443 performs a Monte-Carlo simulation by drawing realizations of the parameters according to the prior parameter distributions. Monte Carlo simulation module 443 obtains approximations which are used by the posterior distribution generation module 442.

Assembly of modules 400 further includes a module for generating an identifier corresponding to a set of distribution of prediction map generation parameter 446, a module for communicating an identifier corresponding to a set of distributions of prediction map generation parameters 448, and a module for identifying the set of distributions of prediction map generation parameters that was used by a mobile wireless device to estimate a mobile device position that was communicated to the network node 450.

Assembly of modules 400 further includes a module for initially modeling a predetermined reference signal transmit power level as a large random variance variable 452. In some embodiments, in addition to initially modeling structure dependent map generation parameters such as wall loss parameters as large variance random variables the transmit power of reference signals from the anchor points are initially modeled as large variance random variables.

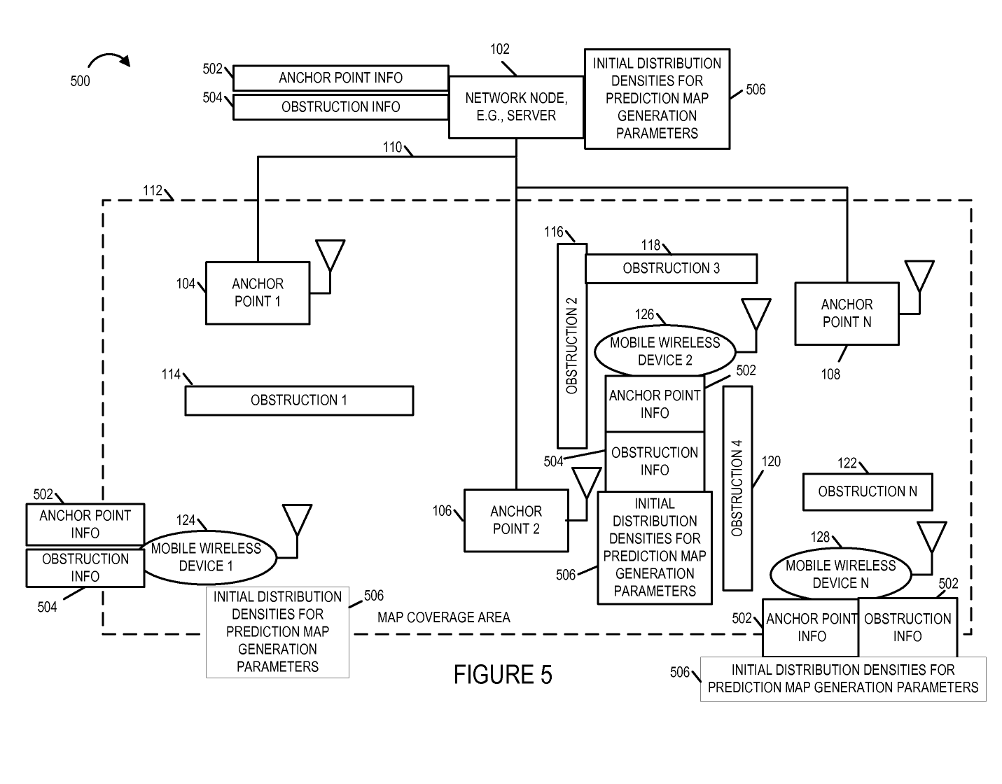

FIG. 5-10 illustrates an example, in which distributions of signal prediction map generation parameters, used to generation a signal prediction map for determining mobile device position, e.g., within a building, are refined in accordance with an exemplary embodiment. In this example, the signal prediction map generation parameters are intentionally initially modeled as large random variance variables.

FIG. 5 is a drawing illustrating exemplary system 100 of FIG. 1 at a first point in time, e.g., an initialization point. The network node 102, e.g., a server, and the mobile wireless devices (mobile wireless device 1 124, mobile wireless device 2 126, . . . , mobile wireless device N 128) each have stored anchor point information 502, stored obstruction information 504 and stored initial distribution densities for prediction map generation parameters 506. Anchor point information 504 includes information identifying the location of the anchor point nodes (anchor point 1 104, anchor point 2 106, . . . , anchor point N 128) within the map coverage area 112 and information identifying the transmission power level of reference signals transmitted from the anchor points (104, 106, . . . , 108). Obstruction information 502 includes information identifying the location of the various obstructions (obstruction 1 114, obstruction 2 116, obstruction 3 118, . . . , obstruction N 122) within the map coverage area, information identifying characteristics of the obstruction, e.g., thickness of a wall, material of a wall with regard to various properties relevant to the prediction map, e.g., which one of a plurality of wall loss parameters applies to the particular obstruction and/or which one of a plurality of reflection loss parameters applies to the particular obstruction.

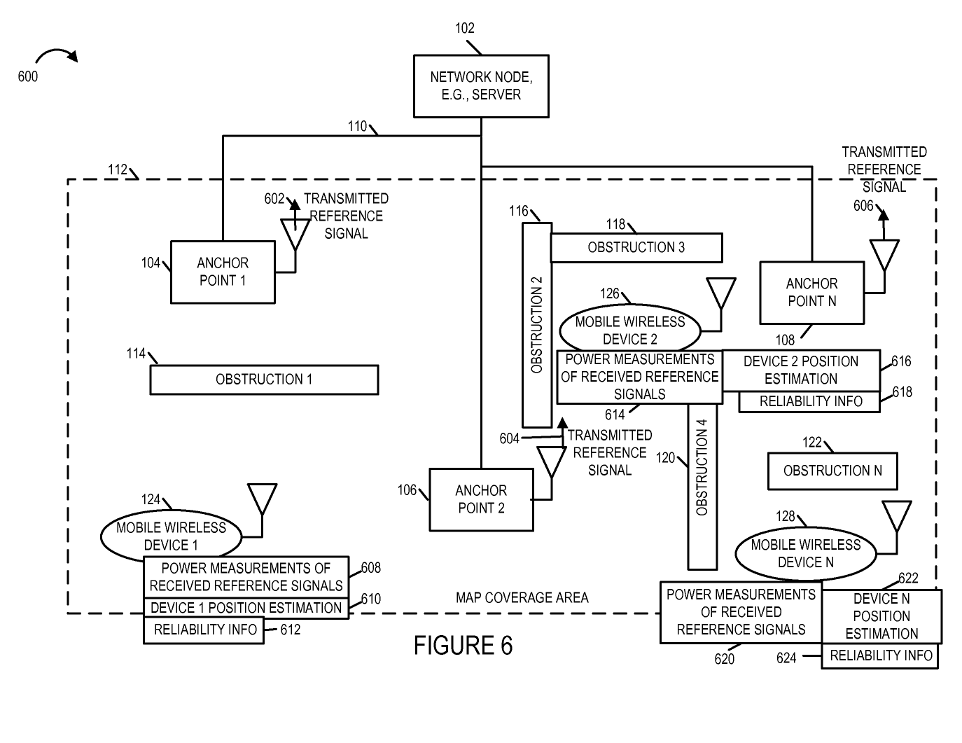

In drawing 600 of FIG. 6, the anchor points (anchor point 1 104, anchor point 2 106, . . . , anchor point N 108) generate and transmit reference signals (602, 604, . . . , 606) respectively. The mobile wireless devices (124, 126, . . . , 128) monitor for and receive at least some of the transmitted reference signals (602, 604, . . . , 606). A received reference signal from a particular anchor point includes one or more of: a direct path component which does not pass through any obstructions, a direct path component which passes through one or more obstructions, a reflected path component, and a refracted path component. At different locations, a mobile wireless device may receive a different mixture of component path types with respect to a particular anchor point. At different locations, a mobile wireless device may be able to receive reference signals from a different set of anchor points.

Mobile wireless device 1 124 measures the received power of the transmitted reference signals (602, 604, . . . , 606) that it is able to detect at its current location and stores the information as information 608. Mobile wireless device 1 124 uses stored anchor point information 502, stored obstruction information 504 and stored initial distribution densities for prediction map generation parameters to generate a location prediction map. Mobile wireless device 1 124 uses the power measurements of the received reference signals 608 and the generated prediction map to estimate its current position. As, part of the location estimation, mobile device 1 124 also generates reliability information corresponding to the position estimation, e.g., a probability information associated with the position estimation. Mobile wireless device 1 124 stores the estimated device 1 position estimation 610 and the corresponding reliability information 612.

Mobile wireless device 2 126 measures the received power of the transmitted reference signals (602, 604, . . . , 606) that it is able to detect at its current location and stores the information as information 614. Mobile wireless device 2 126 uses stored anchor point information 502, stored obstruction information 504 and stored initial distribution densities 506 for prediction map generation parameters to generate a location prediction map. Mobile wireless device 2 126 uses the power measurements of the received reference signals 614 and the generated prediction map to estimate its current position. A, part of the location estimation, mobile device 2 126 also generates reliability information corresponding to the position estimation, e.g., a probability information associated with the position estimation. Mobile wireless device 2 126 stores the estimated device 2 position estimation 616 and the corresponding reliability information 618.

Mobile wireless device N 128 measures the received power of the transmitted reference signals (602, 604, . . . , 606) that it is able to detect at its current location and stores the information as information 620. Mobile wireless device N 128 uses stored anchor point information 502, stored obstruction information 504 and stored initial distribution densities for prediction map generation parameters 506 to generate a location prediction map. Mobile wireless device N 128 uses the power measurements of the received reference signals 620 and the generated prediction map to estimate its current position. As part of the location estimation, mobile device N 128 also generates reliability information corresponding to the position estimation, e.g., a probability information associated with the position estimation. Mobile wireless device N 128 stores the estimated device N position estimation 622 and the corresponding reliability information 624.

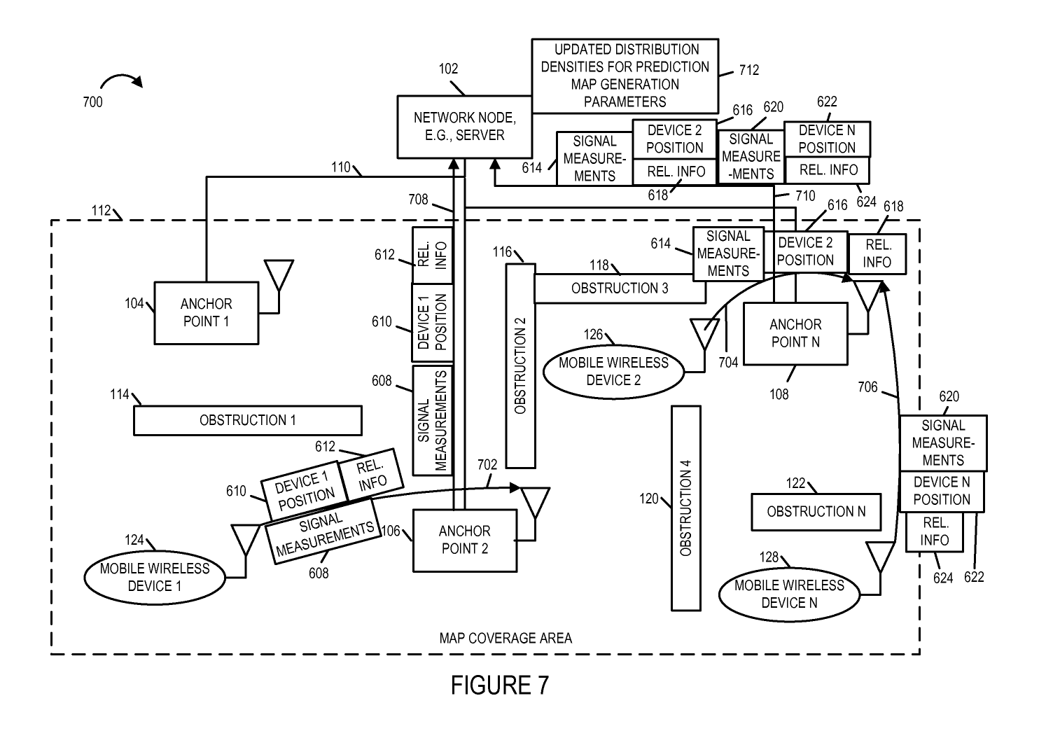

In drawing 700 of FIG. 7, each of the mobile wireless devices (124, 126, . . . , 128) communicate the stored signal measurement information, device position estimation and corresponding estimation reliability information to the network node, e.g., a server, which uses the information to update the distribution densities for the map generation parameters. Mobile wireless device 1 124 generates and transmits wireless signal 702 to anchor point 2 106 communicating signal measurement information 608, device 1 position 610 and corresponding reliability information 612. Mobile wireless device 2 126 generates and transmits wireless signal 704 to anchor point N 108 communicating signal measurement information 614, device 2 position 616 and corresponding reliability information 618. Mobile wireless device N 128 generates and transmits wireless signal 706 to anchor point N 108 communicating signal measurement information 620, device N position 622 and corresponding reliability information 624.

Anchor point 2 106 generates and transmits signal 708 communicating signal measurement information 608, device 1 position 610 and reliability information 612 to network node 102. Anchor point N 108 generates and transmits signal 710 communicating signal measurement information 614, device 2 position 616, reliability information 618, signal measurement information 620, device N position 622, and reliability information 624 to network node 102.

Network node 102, e.g., a server, updates the stored initial distribution densities for prediction map generation parameters 506 based on the received information in signals (708, 710) resulting in updated distribution densities for prediction map generation parameters 712. For different received signal measurements communicated from a mobile wireless device to the server 102, different distribution densities in the set of distribution densities may be updated by the network node, e.g., as a function of the signal path or paths between the anchor point and the mobile. For example, a first mobile may be located with regard to an anchor point such that a signal travels through a wall of a first type with a first wall loss parameter, while a second mobile may be located with regard to an anchor point such that a signal travels through a wall of a second type with a second wall loss parameter, while a third mobile may be located with regard to an anchor point such that a signal from the anchor node to mobile via a direct clear line of sight path with traversing any walls.

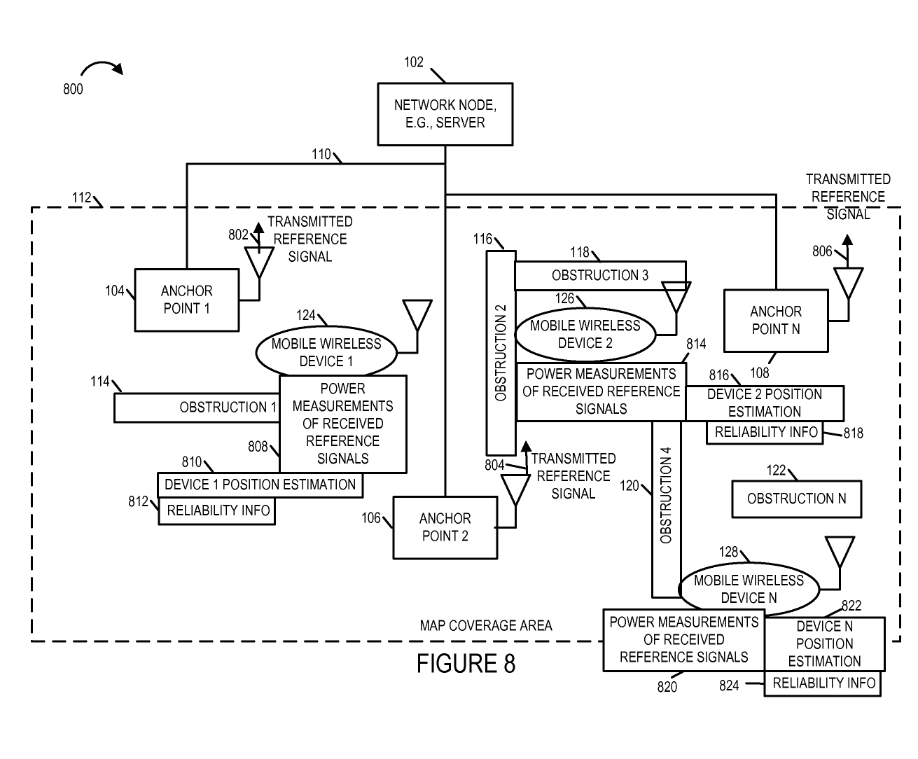

In drawing 800 of FIG. 8, it may be observed that the mobile nodes (124, 126, . . . , 128) have moved to different positions from the position shown in FIG. 6. The anchor points (anchor point 1 104, anchor point 2 106, . . . , anchor point N 108) generate and transmit reference signals (802, 804, . . . , 806) respectively. The mobile wireless devices (124, 126, . . . , 128) monitor for and receive at least some of the transmitted reference signals (802, 804, . . . , 806). A received reference signal from a particular anchor point includes one or more of: a direct path component which does not pass through any obstructions, a direct path component which passes through one or more obstructions, a reflected path component, and a refracted path component.

Mobile wireless device 1 124 measures the received power of the transmitted reference signals (802, 804, . . . , 806) that it is able to detect at its current location and stores the information as information 808. Mobile wireless device 1 124 uses stored anchor point information 502, stored obstruction information 504 and stored initial distribution densities for prediction map generation parameters 506 to generate a location prediction map. Mobile wireless device 1 124 uses the power measurements of the received reference signals 808 and the generated prediction map to estimate its current position. As, part of the location estimation, mobile device 1 124 also generates reliability information corresponding to the position estimation, e.g., a probability information associated with the position estimation. Mobile wireless device 1 124 stores the estimated device 1 position estimation 810 and the corresponding reliability information 812.

Mobile wireless device 2 126 measures the received power of the transmitted reference signals (802, 804, . . . , 806) that it is able to detect at its current location and stores the information as information 814. Mobile wireless device 2 126 uses stored anchor point information 502, stored obstruction information 504 and stored initial distribution densities for prediction map generation parameters 506 to generate a location prediction map. Mobile wireless device 2 126 uses the power measurements of the received reference signals 814 and the generated prediction map to estimate its current position. As, part of the location estimation, mobile device 2 126 also generates reliability information corresponding to the position estimation, e.g., a probability information associated with the position estimation. Mobile wireless device 2 126 stores the estimated device 2 position estimation 816 and the corresponding reliability information 818.

Mobile wireless device N 128 measures the received power of the transmitted reference signals (802, 804, . . . , 806) that it is able to detect at its current location and stores the information as information 820. Mobile wireless device N 128 uses stored anchor point information 502, stored obstruction information 504 and stored initial distribution densities for prediction map generation parameters 506 to generate a location prediction map. Mobile wireless device N 128 uses the power measurements of the received reference signals 820 and the generated prediction map to estimate its current position. As, part of the location estimation, mobile device N 128 also generates reliability information corresponding to the position estimation, e.g., a probability information associated with the position estimation. Mobile wireless device N 128 stores the estimated device N position estimation 822 and the corresponding reliability information 824.

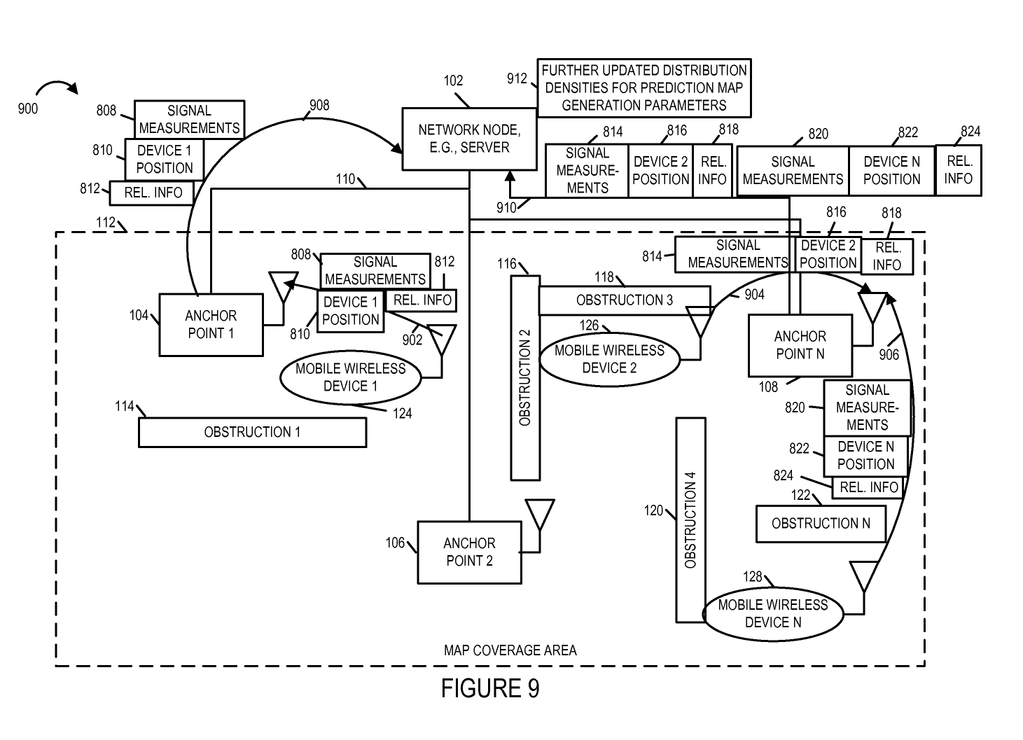

In drawing 900 of FIG. 9, each of the mobile wireless devices (124, 126, . . . , 128) communicate the stored signal measurement information, device position estimation and corresponding estimation reliability information to the network node, e.g., a server, which uses the information to update the distribution densities for the map generation parameters. Mobile wireless device 1 124 generates and transmits wireless signal 902 to anchor point 1 104 communicating signal measurement information 808, device 1 position 810 and corresponding reliability information 812. Mobile wireless device 2 126 generates and transmits wireless signal 904 to anchor point N 108 communicating signal measurement information 814, device 2 position 816 and corresponding reliability information 818. Mobile wireless device N 128 generates and transmits wireless signal 906 to anchor point N 108 communicating signal measurement information 820, device N position 822 and corresponding reliability information 824.

Anchor point 1 104 generates and transmits signal 908 communicating signal measurement information 808, device 1 position 810 and reliability information 812 to network node 102. Anchor point N 108 generates and transmits signal 910 communicating signal measurement information 814, device 2 position 816, reliability information 818, signal measurement information 820, device N position 822, and reliability information 824 to network node 102.

Network node 102, e.g., a server, updates the currently stored distribution densities for prediction map generation parameters 712 based on the received information in signals (908, 910) resulting in further updated distribution densities for prediction map generation parameters 912. For different received signal measurements communicated from a mobile wireless device to the server 102, different distribution densities in the set of distribution densities may be updated by the network node, e.g., as a function of the signal path or paths between the anchor point and the mobile.

This process of the network node, e.g., server, collecting information from the mobile devices and updating distribution densities for prediction map generation parameters may, and sometimes does, go for additional iterations, e.g., multiple iterations of FIG. 8 and FIG. 9. At some point, in time, the network node decides to communicate updated distribution density information for prediction map generation parameters. In some embodiments, the updated information is communicated when at least one of the distribution densities for a prediction map generation parameter has been updated at least a predetermined number of times. In some embodiments, the updated information is communicated when each of the distribution densities for the prediction map generation parameters have been updated at least a predetermined number of times. In some embodiments, for at least some of the parameters different predetermined numbers of times updates are performed apply to different parameters. For example, a first predetermined update count may apply to first wall loss parameter and a second predetermined update number may apply to a diffraction parameter. In some embodiments, an entire set of updated distribution densities is communicated, e.g., corresponding to each of the parameters used in generating a prediction map. In some other embodiments, a partial update of the set of parameters may be, and sometimes is performed. For example, a distribution density corresponding to a wall loss parameter may be communicated at one time and a distribution density corresponding to a diffraction loss parameter may be communicated at another time.

In some embodiments, the decision to communicate updated distribution densities for prediction map generation parameters is in response to a request from a mobile device. In some embodiments, the decision to communicate updated distribution densities for prediction map generation parameters is based on time, e.g., a scheduled update. In some embodiments, the decision to communicate updated distribution densities for prediction map generation parameters is in response to a change in one or more distribution densities by a predetermined amount.

In some embodiments, a set of distribution densities for prediction parameters that may be used in the system is identified by an identifier, which is under the control of the network node 102, which communicates the identifier with the updated distribution information. In some embodiments, at different times at least some mobile wireless devices in the system may be using different sets of distribution densities for prediction map generation parameters. In some such embodiments, signals communicating mobile device determined location information includes information identifying which particular set of distribution densities for prediction map generation parameters was used by the mobile device when determining its location.

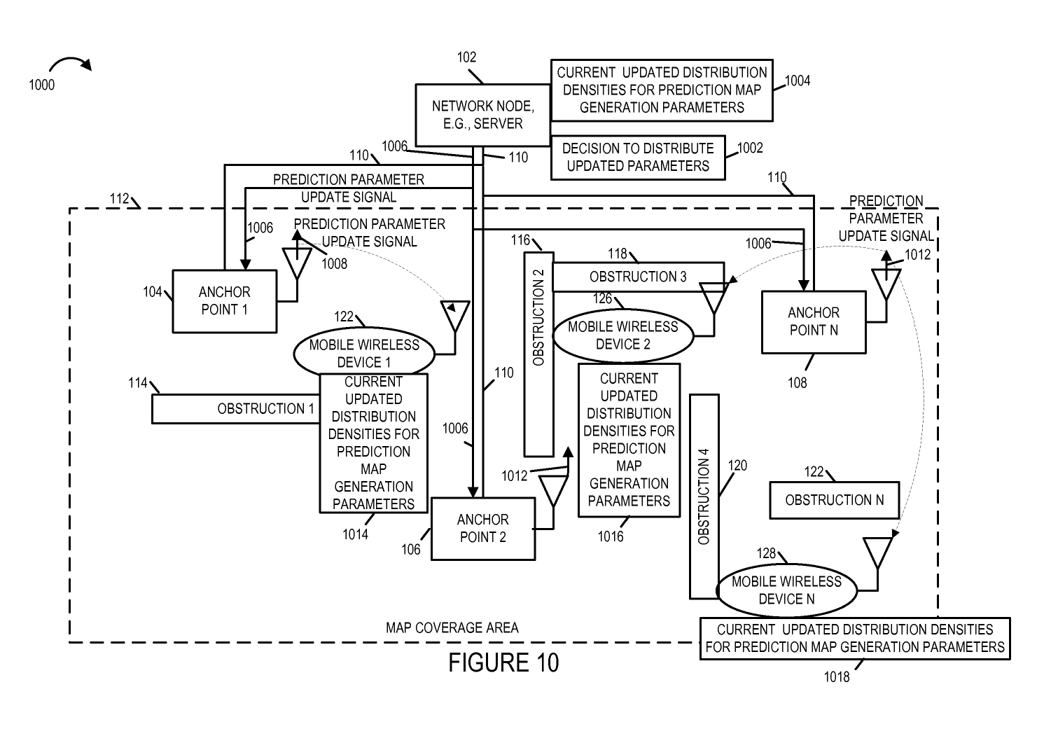

In FIG. 10 consider that network node 102 has decided to distribute updated distribution densities for prediction map generation parameters, as indicated by block 1002. In this example, network node 102 generates a prediction parameter update signal 1006 communicating current updated distribution densities for prediction map generation parameters 1004 and transmits signal 1006 over backhaul network 110 to the anchor point nodes (104, 106, . . . , 108). Anchor point nodes (104, 106, . . . , 108) receive signal 110 and generate prediction parameter update signals (1008, 1010, . . . , 1012) which they broadcast over the airlink. The wireless mobile devices (124, 126, . . . , 128) received one or more of signals (1008, 1010, . . . , 1012) and recover the current updated distribution densities for prediction map generation parameters 1004 which is being communicated. The wireless mobile devices (124, 126, . . . , 128) store the current updated distribution densities for prediction map generation parameters 1004 as information (1014, 1016, . . . , 1018), respectively, which replaces the initial distribution densities for prediction map generation parameters 506. The updated distribution densities for prediction map generation parameters are now used by the mobile wireless devices for subsequent position estimation. Further iteration of the mobiles measuring reference signals, estimating location, communicating measurement and location information to the network node, e.g. server, the server updating the distribution densities based on the received information, and the network node, communicating the updated distributions to the mobiles may be, and sometimes is performed, e.g., to further refine the distribution densities of the prediction map generation parameters to result in a more accurate prediction map.

Various features and/or aspects of some embodiments are discussed below. Various embodiments are directed to addressing the problem of learning of the parameters of a fingerprint prediction map used for the positioning of mobile devices. In some embodiments, the learning is performed at a network device such as, e.g., a server. In some embodiments, the learning and positioning are performed by different entities.

A network device, e.g., a server, receives a set of positions of mobiles and a corresponding set of signal measurements taken at those positions from a number of mobiles that have previously determined their position. The network device then computes an updated set of parameters and sends those parameters back to the mobiles. In particular, in one exemplary embodiment, the updates are posterior distribution calculations of the parameters, given the positions and the signal measurements. The mobiles use the updated parameters received from the network device to generate a new prediction map, e.g., a set of distributions with one distribution for each location, and use that map to position themselves. Alternatively, in another exemplary embodiment, the network device generates a prediction map based on the update parameters and sends the prediction map itself rather than the parameters, although this approach is much more costly since it's uncompressed. In various embodiments a set of prediction map generation parameters is a compressed description of the prediction map. For example, in some embodiments, a set of prediction map generation parameters, which can be represented by a relatively small amount of stored values, can be used in combination with known obstruction information and known anchor point information to derive expected signal measurement values at various locations throughout the coverage area.

The network device uses the available information, which includes positions and measurements, to come up with a new set of parameters, e.g., distributions of prediction map generation parameters, and sends the updates or the prediction map based on them to the mobiles. In various embodiments, the determination of position is to be done by the mobile device itself which may use the prediction map and/or other methods such as, e.g., manual intervention, to initially position itself. In some embodiments, a fingerprint prediction map is defined as a spatial distribution of probability densities associated with a particular characteristic of a signal. The signal may be a RF in nature, sound, temperature, light, etc. The characteristic may be the received power, delay spread or delay profile, frequency, etc.

In one embodiment, the signal characteristic is the received RF power of signals transmitted by anchor devices, e.g., mobile or fixed devices whose locations are known. The prediction map, along with real-time or near real-time measurements of the signal characteristics is used by mobile devices for positioning. One way to describe the fingerprint prediction map is by storing a sampled version of the probability density for every location in the space of interest. This method of storage/description of the prediction map is lossless yet requires significant storage and potentially a large amount of communication resources if the information is to be exchanged between devices. Another way is to parameterize the densities with fewer parameters and store only the parameters themselves, assuming knowledge of the functional form that translates the parameters to the full prediction map. In some embodiments, very few parameters are needed to describe the prediction map to a reasonably high degree of accuracy. In some embodiments, the parameters are related to the wave propagation mechanism: path loss exponents, diffraction losses, refraction losses, etc.

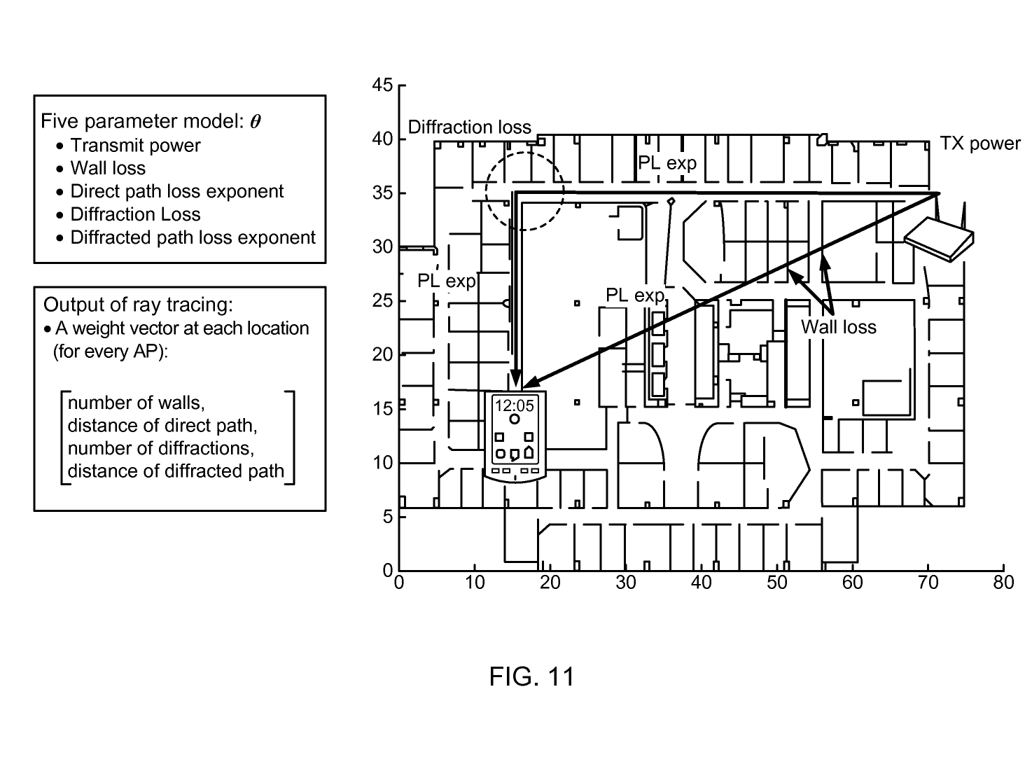

Drawing 1100 of FIG. 11 illustrates an exemplary five parameter model 1102 for generating a signal prediction map which includes: a transmit power parameter, a wall loss parameter, a direct path loss exponent parameter, a diffraction loss parameter, and a diffracted path loss exponent parameter. Drawing 1104 illustrates an exemplary map coverage area including an access point (AP) serving as an anchor point which has a TX power level, an exemplary mobile wireless device, and exemplary obstructions, e.g., walls. Drawing 1104 also illustrates an exemplary first signal path between the access point and the mobile in which the signal passes through walls experiencing wall loss in accordance with the wall loss parameter and the number of walls through which the signal passes and experiences path loss in accordance with the direct path loss exponent and distance travelled. Drawing 1104 also illustrates an exemplary second signal path between the access point and the mobile in which the signal is refracted around a corner experiencing loss in accordance with the diffraction loss parameter and the diffracted path loss exponent parameter and experiences path loss in accordance with the direct path loss exponent and distance travelled. Block 1106 of drawing 1100 of FIG. 11 illustrates an exemplary output of ray tracing, e.g., a weight vector at each location for each access point. The exemplary weight vector includes number of walls, a distance of direct path, a number of diffractions and a distance of diffracted path.

Traditional approaches have typically treated the parameter vector as a deterministic quantity. In a deterministic prediction method the parameter values are treated as deterministic quantities. The quantity m(θ, s) is calculated using the ray-tracing weight vectors. For every location in space, the density of power measurements are given by the small-scale fading distribution pₛₛ(y|m(θ,s)) with mean given by m(θ,s). Typically the small scale fading is exponentially distributed.

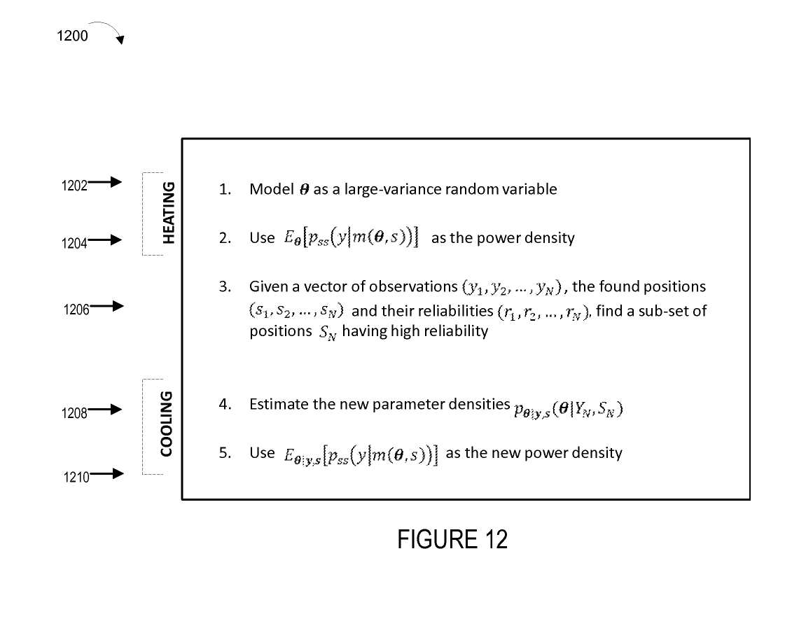

By contrast, one of the novelties of various embodiments of the new exemplary approach is that the parameters are modeled as random variables because, a priori, their true values (nature-selected) are not known. During the learning phase, the server calculates the posterior distributions of the parameters using the knowledge of the functional form that translates parameter values to the prediction map densities for every location in the physical space of interest. The parameter distributions are referred to as “posterior distributions” because they are calculated based on the measurements of the signal characteristics, e.g., observations, supplied by the mobiles as well as the positions where they were obtained. The parameter distribution update method, used in some embodiments, can be summarized in the steps illustrated in drawing 1200 of FIG. 12.

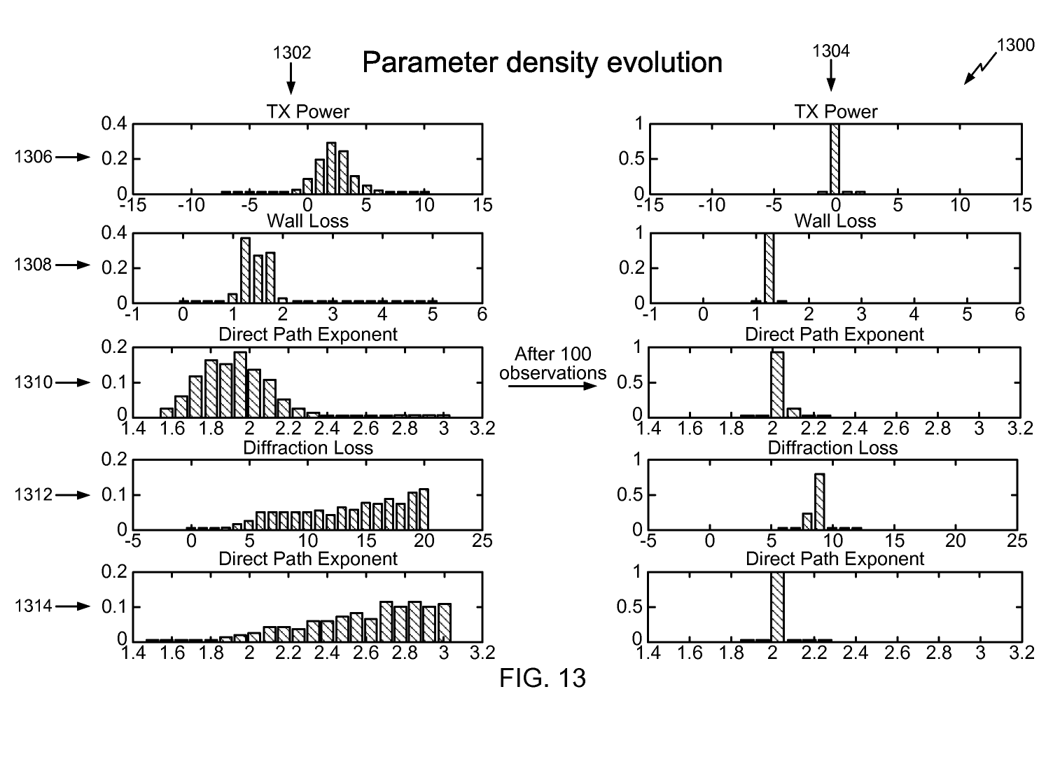

The parameters are modeled as random variables in step (1202), e.g., large variance random variables, and, to every point in space, a distribution, which is obtained by averaging the small-scale fading distribution at that point over the prior (high-variance) densities of the parameters, is assigned in step 2 (1204). We refer to this portion of the method step 1 (1202) and step 2 (1204) as “heating” the small-scale fading densities. The effective power densities have a higher variance than the original small scale fading densities and this ensures that the positioning method does not get stuck in local maxima. In some embodiments these operations takes place at the server. The heated power densities are then transmitted to the mobiles which use these power densities, a.k.a. the power map, to determine their positions. The positions are then fed back to the server, along with the signal power measurements (1206). The positions and measurements are then used to estimate new parameter densities in step 4 (1208). The calculation can be thought of as transforming the prior distributions of the parameters, which are typically of high-variance and having arbitrarily selected means, to more informed posterior distributions which have lower variance, thereby being more reliable, and means that more closely approximate the parameter values chosen by nature. This is illustrated in drawing 1300 of FIG. 13, which shows the empirically observed evolution of the parameter densities as more and more positions and power measurements are taken. In step 5 (1210), the power densities at each point in space are averaged over the newly estimated posterior parameter distributions. Since the new parameter distributions have smaller variance than the prior parameter densities, we call this combination of steps 4 (1208) and step 5 (1210) as “cooling” of the power densities around the true means as chosen by nature.

The benefits of posterior parameter estimation include improved positioning accuracy and also improved accuracy of the reliability metrics. This approach using posterior parameter estimation is an improvement, as compared to the approach in which the parameters are modeled as deterministic variables.

The calculation of the posterior parameter distributions is, typically, a highly complex task since closed-form expressions can rarely be found. In some embodiments, these calculations are approximated using a Monte-Carlo simulation by drawing realizations of the parameters according to the prior parameter distributions. The posterior distribution calculations may be done for every observation sample or for a block of observations samples and may be iterative in nature so that the previously calculated posterior distributions are treated as prior distributions for the next batch of calculations.

Once calculated, the posterior parameter distributions are transmitted by the network device to the mobiles, where they are used to generate new prediction maps which are, in turn, used for positioning. The transmission can be done from a number of access points that communicate directly to the network device, e.g., server. The transmissions may be triggered by a mobile device request or may be transmitted periodically in a broadcast fashion, e.g., depending on the particular embodiment.

FIG. 13 includes drawing 1300 illustrating exemplary parameter density evolution in an exemplary embodiment for five exemplary parameters which have been initially modeled as high variance random variables. Row 1306 corresponds to a transmit power parameter. Row 1308 corresponds to a wall loss parameter. Row 1310 corresponds to a direct path exponent parameter. Row 1312 corresponds to a diffraction loss parameter. Row 1314 corresponds to a diffracted path exponent parameter. Column 1302 illustrates initial modeling of the parameters as high random variance variables. Column 1304 illustrates the parameters after 100 observations. The change from column 1302 to column 1304 illustrates exemplary parameter density evolution.

Various methods and apparatus described in this application are well suited for use in wireless communications devices and networks supporting location determination, e.g., within a building, based on wireless signal measurements. In various embodiments a device of any of one or more of FIGS. 1-13 includes a module corresponding to each of the individual steps and/or operations described with regard to any of the Figures in the present application and/or described in the detailed description of the present application. The modules may, and sometimes are implemented in hardware. In other embodiments, the modules may, and sometimes are, implemented as software modules including processor executable instructions which when executed by the processor of the wireless communications device cause the device to implement the corresponding step or operation. In still other embodiments, some or all of the modules are implemented as a combination of hardware and software.

The techniques of various embodiments may be implemented using software, hardware and/or a combination of software and hardware. Various embodiments are directed to apparatus, e.g., mobile wireless communications devices, e.g., mobile nodes such as mobile terminals, stationary wireless communications devices such as access points such as base stations, network nodes, e.g., a server node, and/or communications systems. Various embodiments are also directed to methods, e.g., methods of controlling and/or operating a network node such as a server, methods of controlling and/or operating a wireless communications device such as a mobile node and/or a stationary node, e.g., an anchor point and/or access point such as base station, and/or methods of controlling and/or operating a system, e.g., a wireless communications system supporting mobile device position location and/or hosts. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In various embodiments nodes described herein are implemented using one or more modules to perform the steps corresponding to one or more methods, for example, signal reception, signal processing, signal generation and/or transmission steps. Thus, in some embodiments various features are implemented using modules. Such modules may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a network node such as a server, including a processor configured to implement one, multiple or all of the steps of one or more methods of the invention.

In some embodiments, the processor or processors, e.g., CPUs, of one or more devices, e.g., communications nodes such as wireless terminals, access nodes, and/or network nodes, are configured to perform the steps of the methods described as being performed by the communications nodes. The configuration of the processor may be achieved by using one or more modules, e.g., software modules, to control processor configuration and/or by including hardware in the processor, e.g., hardware modules, to perform the recited steps and/or control processor configuration. Accordingly, some but not all embodiments are directed to a device, e.g., a server or a communications node, with a processor which includes a module corresponding to each of the steps of the various described methods performed by the device in which the processor is included. In some but not all embodiments a device, e.g., a server or a communications node, includes a module corresponding to each of the steps of the various described methods performed by the device in which the processor is included. The modules may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g. one or more steps described above. Depending on the embodiment, the computer program product can, and sometimes does, include different code for each step to be performed. Thus, the computer program product may, and sometimes does, include code for each individual step of a method, e.g., a method of controlling a communications device or node. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device or other device described in the present application.

Various embodiments are well suited to communications systems using a peer to peer signaling protocol. Some embodiments use an Orthogonal Frequency Division Multiplexing (OFDM) based wireless peer to peer signaling protocol, e.g., WiFi signaling protocol or another OFDM based protocol.

While described in the context of an OFDM system, at least some of the methods and apparatus of various embodiments are applicable to a wide range of communications systems including many non-OFDM and/or non-cellular systems.

Numerous additional variations on the methods and apparatus of the various embodiments described above will be apparent to those skilled in the art in view of the above description. Such variations are to be considered within the scope. The methods and apparatus may be, and in various embodiments are, used with Code Division Multiple Access (CDMA), OFDM, and/or various other types of communications techniques which may be used to provide wireless communications links between communications devices. In some embodiments one or more communications devices are implemented as access points which establish communications links with mobile nodes using OFDM and/or CDMA and/or may provide connectivity to the internet or another network via a wired or wireless communications link. In various embodiments the mobile nodes are implemented as notebook computers, personal data assistants (PDAs), or other portable devices including receiver/transmitter circuits and logic and/or routines, for implementing the methods.

What is claimed is:

1. A method of operating a network device, the method comprising:
receiving a signal measurement and a position of a first mobile wireless device;
updating a previous distribution of a first signal prediction map generation parameter based on the signal measurement and the position of the first mobile wireless device to generate an updated distribution of the first signal prediction map generation parameter, said first signal prediction map generation parameter being a building structure dependent parameter; and
transmitting a prediction parameter update signal communicating the updated distribution of the first signal prediction map generation parameter to a mobile wireless device.

2. The method of claim 1, wherein said updated distribution includes a plurality of quantized probability values corresponding to said first parameter.

3. The method of claim 2, further comprising:
receiving a second signal measurement and a second position of a second mobile wireless device;
updating said updated distribution of the first signal prediction map generation parameter based on the second signal measurement and the second position of the second mobile wireless device to generate a new updated distribution of the first signal prediction map generation parameter; and
broadcasting a second prediction parameter update signal communicating the new updated distribution of the first signal prediction map generation parameter to multiple mobile devices.

4. The method of claim 1, wherein said distribution of a first signal prediction map generation parameter is an initial distribution density of said first parameter which is not based on a signal measurement provided by a mobile wireless terminal.

5. The method of claim 1, wherein transmitting the prediction parameter update signal communicating the updated distribution of the first signal prediction map generation parameter is performed after a predetermined number of updates of said distribution of the first signal prediction map generation parameter have been performed since a previous transmission of the first signal prediction map generation parameter.

6. The method of claim 5, wherein said transmitting the prediction parameter update signal is performed as part of transmitting a set of prediction map update parameters.

7. A network device comprising:
means for receiving a signal measurement and a position of a first mobile wireless device;
means for updating a previous distribution of a first signal prediction map generation parameter based on the signal measurement and the position of the first mobile wireless device to generate an updated distribution of the first signal prediction map generation parameter, said first signal prediction map generation parameter being a building structure dependent parameter; and
means for transmitting a prediction parameter update signal communicating the updated distribution of the first signal prediction map generation parameter to a mobile wireless device.

8. The network device of claim 7, wherein said updated distribution includes a plurality of quantized probability values corresponding to said first parameter.

9. The network device of claim 8, further comprising:
means for receiving a second signal measurement and a second position of a second mobile wireless device;
means for updating said updated distribution of the first signal prediction map generation parameter based on the second signal measurement and the second position of the second mobile wireless device to generate a new updated distribution of the first signal prediction map generation parameter; and
means for broadcasting a second prediction parameter update signal communicating the new updated distribution of the first signal prediction map generation parameter to multiple mobile devices.

10. The network device of claim 7, wherein said previous distribution of a first signal prediction map generation parameter is an initial distribution density of said first parameter which is not based on a signal measurement provided by a mobile wireless terminal.

11. The network device of claim 7, wherein said means for transmitting the prediction parameter update signal communicates the updated distribution of the first signal prediction map generation parameter after a predetermined number of updates of said distribution of the first signal prediction map generation parameter have been performed since a previous transmission of the first signal prediction map generation parameter.

12. The network device of claim 11, wherein said means for transmitting the prediction parameter update signal transmits the prediction parameter update signal performed as part of transmitting a set of prediction map update parameters.

13. A computer program product for use in a network device, the computer program product comprising:
a non-transitory computer readable medium comprising:
code for causing at least one computer to receive a signal measurement and a position of a first mobile wireless device;
code for causing said at least one computer to updating a previous distribution of a first signal prediction map generation parameter based on the signal measurement and the position of the first mobile wireless device to generate an updated distribution of the first signal prediction map generation parameter, said first signal prediction map generation parameter being a building structure dependent parameter; and
code for causing said at least one computer to transmit a prediction parameter update signal communicating the updated distribution of the first signal prediction map generation parameter to a mobile wireless device.

14. The computer program product of claim 13, wherein said updated distribution includes a plurality of quantized probability values corresponding to said first parameter.

15. A network device comprising:
at least one processor configured to:
receive a signal measurement and a position of a first mobile wireless device;
update a previous distribution of a first signal prediction map generation parameter based on the signal measurement and the position of the first mobile wireless device to generate an updated distribution of the first signal prediction map generation parameter, said first signal prediction map generation parameter being a building structure dependent parameter; and
transmit a prediction parameter update signal communicating the updated distribution of the first signal prediction map generation parameter to a mobile wireless device; and
memory coupled to said at least one processor.

16. The network device of claim 15, wherein said updated distribution includes a plurality of quantized probability values corresponding to said first parameter.

17. The network device of claim 16, wherein said at least one processor is further configured to:
receive a second signal measurement and a second position of a second mobile wireless device;
update said updated distribution of the first signal prediction map generation parameter based on the second signal measurement and the second position of the second mobile wireless device to generate a new updated distribution of the first signal prediction map generation parameter; and
broadcast a second prediction parameter update signal communicating the new updated distribution of the first signal prediction map generation parameter to multiple mobile devices.

18. The network device of claim 15, wherein previous distribution of a first signal prediction map generation parameter is an initial distribution density of said first parameter which is not based on a signal measurement provided by a mobile wireless terminal.

19. The network device of claim 15, wherein said at least one processor is configured to perform the transmitting of the prediction parameter update signal communicating the updated distribution of the first signal prediction map generation parameter after a predetermined number of updates of said distribution of the first signal prediction map generation parameter have been performed since a previous transmission of the first signal prediction map generation parameter

20. The network device of claim 19, wherein said at least one processor is configured to perform the transmitting of the prediction parameter update signal as part of transmitting a set of prediction map update parameters.
